(19) United States
(12) Patent Application Publication
(10) Pub. No.: US 2023/0339432 A1
(43) Pub. Date: Oct. 26, 2023

(54) MOTORIZED ICE REMOVAL WINDSHIELD WIPER DEVICE

(71) Applicant: Michael Mollett, Marysville, OH (US)

(72) Inventor: Michael Mollett, Marysville, OH (US)

(21) Appl. No.: 17/725,660

(22) Filed: Apr. 21, 2022

(51) Int. Cl. B60S 1/08; B60S 1/04; B60S 1/34

(52) U.S. Cl. CPC B60S 1/0814; B60S 1/0477; B60S 1/3404

(57) ABSTRACT

A motorized ice removal windshield wiper device for removing ice includes a blade having a base nested within a housing. The blade abuts a surface of a windshield. An arm is coupled to the housing by an articulation point. The arm has an interior defining a space for a variety of elements to be positioned within. In addition, a lever is positioned within the interior of the arm. The lever moves the housing from a lowered positioned to an upper position, and vise versa. A motor is positioned on an end of the lever. The motor moves the lever, thus moving the housing. A motor control is in electric communication with the motor. The motor control is an actuator to the motor.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to wiper blade devices and more particularly pertains to a new wiper blade device for removing ice.

### (2) Description of Related Art Including Information Disclosed Under 37 CFR 1.97 and 1.98

The prior art relates to wiper blade devices. The prior art relates to a variety of wiper blade devices being configured for raising and lowering to remove the ice from the blades. Known prior art lacks a wiper blade device having a motorized lever to rise and lower the blade, wherein the lever additionally has a plurality of heating coils to facilitate the functionality of the lever.

### BRIEF SUMMARY OF THE INVENTION

An embodiment of the disclosure meets the needs presented above by generally comprising a blade having a base nested within a housing. The blade is configured for abutting a surface of a windshield. An arm is coupled to the housing by an articulation point. The arm has an interior defining a space for a variety of elements to be positioned within. A lever is positioned within the interior of the arm. The lever is configured for moving the housing from a lowered positioned to an upper position and vise versa. A motor is positioned on an end of the lever. The motor is configured for moving the lever whereby moving the housing. A motor control is in electric communication with the motor. The motor control is configured for being an actuator to the motor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a motorized ice removal windshield wiper device according to an embodiment of the disclosure.

FIG. 2 is a rear view of an embodiment of the disclosure.

FIG. 3 is a top view of an embodiment of the disclosure.

### DETAILED DESCRIPTION OF THE INVENTION

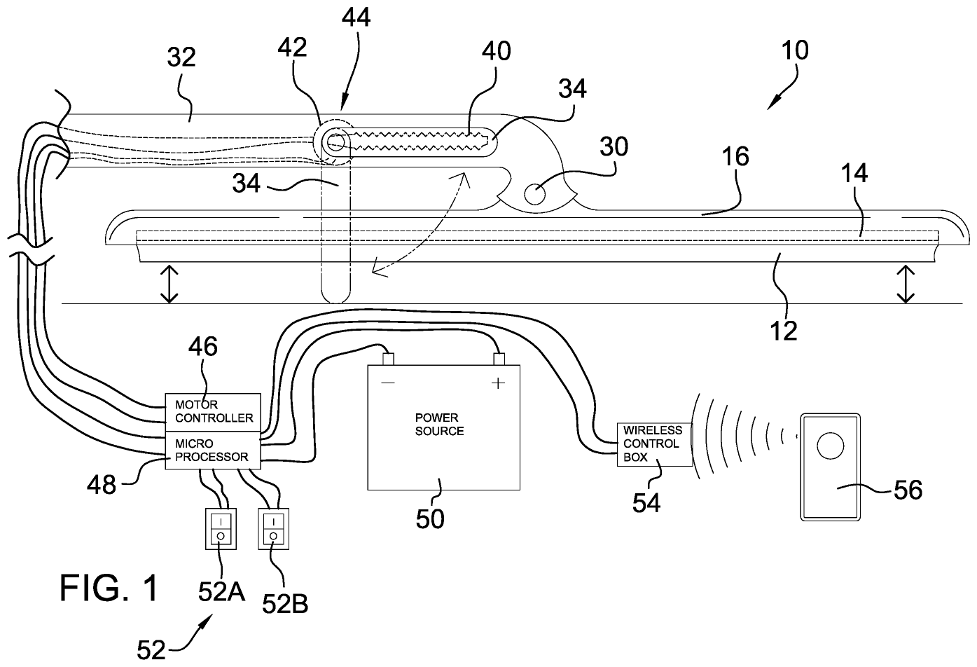

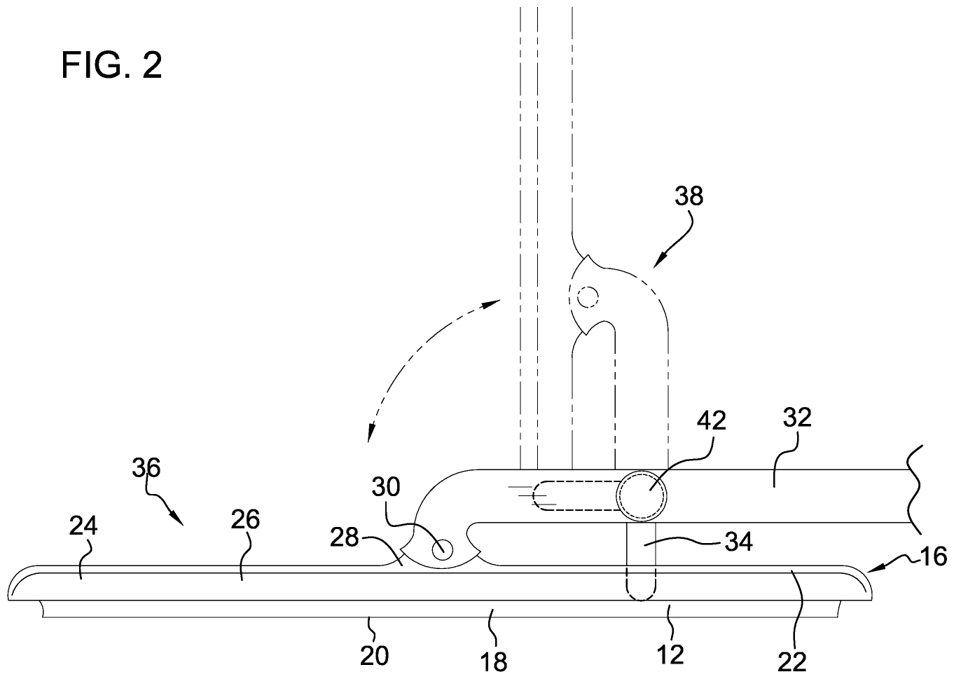

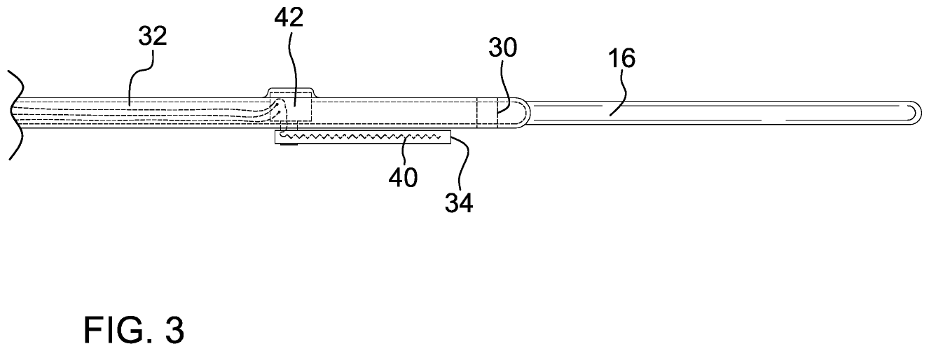

With reference now to the drawings, and in particular to FIGS. 1 through 3 thereof, a new wiper blade device embodying the principles and concepts of an embodiment of the disclosure and generally designated by the reference numeral 10 will be described.

As best illustrated in FIGS. 1 through 3, the motorized ice removal windshield wiper device 10 generally comprises a blade 12 having a base 14. The base 14 is nested within a housing 16. The blade 12 is a rubber material 18. The rubber material 18 repeals liquid properties, wherein the water on the windshield is removed with the rubber material 18 of the blade 12. The blade 12 has an edge 20 being shrilled. The shrilled edge 20 reduces the amount of surface area that the blade 12 touches the windshield with, wherein increasing the mobility of the blade 12. The blade 12 is configured for abutting the windshield when in-use.

The housing 16 of the blade 12 is configured for providing protective cover to the blade 12. The housing 16 has a first end 22 and a second end 24. The blade 12 is configured for being elongated from the first end 22 to the second end 24 of the housing 16. Additionally, the housing 16 has a surface 26. The surface 26 of the housing has a center 28 where an articulation point 30 is positioned on. The articulation point 30 couples an arm 32 to the housing 16. The arm 32 is positioned parallel relative to the blade 12. Furthermore, the arm 32 is positioned proximate to the first end 22 of the housing 16. The arm 32 has an interior that defines a space for a variety of elements to be positioned within.

A lever 34 is positioned within the interior of the arm 32. The lever 34 is configured for moving the housing 16 from a lowered position 36 to an upper position 38, and vise versa. The lower position 36 includes the blade 12 abutting the windshield. The upper position 38 includes the blade 12 being positioned at a raised angle relative to the windshield. Additionally, the lever 34 has a plurality of heating coils 40. Each of the heating coils 40 is configured for warming the arm 32 to remove ice whereby facilitating the functions of the lever 34.

A motor 42 is positioned on an end 44 of the lever 34. The motor 42 is electric and is configured for moving the lever 34, whereby moving the housing 16 of the blade 12. A motor control 46 is in electric communication with the motor 42. The motor control 46 is configured for being an actuator to the motor 42. The motor control 46 adjusts the speed of the motor 42, whereby lowering the housing 16 at an accelerating speed to increase force upon the blade 12 to remove ice from the housing 16.

A microprocessor 48 is in electric communication with the plurality of heating coils 40 of the lever 34. The microprocessor 48 is an actuator to each of the heating coils and sends each of the heating coils 40 electric power whereby warming the lever 34. The microprocessor 48 and the motor control 46 are in electric communication with a power source 50. The power source 50 is a battery being configured for sending electric power to the motorized ice removal windshield wiper device 10. The power source 50 can be a known product such as a car battery.

Each control switch 52 of a pair of control switches 52 is configured for sending commands to a respective one of the microprocessor 48 and the motor control 46. A first control switch 52A of the pair of control switches 52 is used to start and stop the motor 42. A second control switch 52B of the pair of control switches 52 is used to enable the plurality of heating coils 40. Additionally, a wireless control 54 is in electric communication with the microprocessor 48 and the motor control 46. The wireless control 54 is in remote communication with a remote device 56. The remote device 56 can act as the pair of control switches 52 and can be used outside of the vehicle.

In use, the second control switch 52B turns on the plurality of heating coils 40 to melt ice on the arm 32. When the ice is melted off the arm 32, the first control switch 52A can start the motor 42. The motor 42 decelerating raises the housing 16 of the blade 12 from the lowered position 36 to the upper position 38. Subsequently, the motor 42 reverses direction and accelerating lowers the housing 16 of the blade 12 from the upper position 38 to the lowered position 36. The blade 12 rebounds off the windshield, wherein the force of the blade 12 can remove ice from the housing 16 of the blade 12. This process is repeated until the desired amount of ice is removed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mechanized windshield wipe device configured for removing ice buildup from the wipers. The device comprising:
a blade having a base being nested within a housing, the blade being configured for abutting a surface of a windshield;
an arm being coupled to the housing by an articulation point, the arm having an interior defining a space for a variety of elements to be positioned within;
a lever being positioned within the interior of the arm, the lever being configured for moving the housing from a lowered positioned to an upper position and vise versa;
a motor being positioned on an end of the lever, the motor being configured for moving the lever whereby moving the housing; and
a motor control being in electric communication with the motor, the motor control being configured for being an actuator to the motor.

2. The mechanized windshield wipe device of claim 1, further comprising the blade being a rubber material, the blade having an edge, the edge being shrilled.

3. The mechanized windshield wipe device of claim 1, further comprising the housing being configured for providing protective cover to the blade, the housing having a first end and a second end, the blade being configured for being elongated from the first end to the second end.

4. The mechanized windshield wipe device of claim 3, further comprising the housing having a center on a surface of the housing.

5. The mechanized windshield wipe device of claim 4, further comprising an the articulation point being positioned on the center of the surface of the housing.

6. The mechanized windshield wipe device of claim 3, further comprising the arm being positioned parallel relative to the blade, the arm being positioned proximate to the first end of the housing of the blade.

7. The mechanized windshield wipe device of claim 1, further comprising the lever having a plurality of heating coils.

8. The mechanized windshield wipe device of claim 7, further comprising a microprocessor being in electric communication with the plurality of heating coils, the microprocessor being configured for being an actuator to the plurality of heating coils.

9. The mechanized windshield wipe device of claim 1, further comprising a power source being a battery, the power source being configured for sending electric power to the mechanized windshield wipe device.

10. The mechanized windshield wipe device of claim 8, further comprising a pair of control switches being configured for sending commands to a respective one of the microprocessor and the motor control.

11. The mechanized windshield wipe device of claim 10, further comprising a wireless control being in remote communication with a remote device, the wireless control being in electric communication with the microprocessor and the motor control.

12. A mechanized windshield wipe device configured for removing ice buildup from the wipers. The device comprising:
a blade having a base being nested within a housing, the blade being a rubber material, the blade having an edge, the edge being shrilled, the blade being configured for abutting a surface of a windshield, the housing being configured for providing protective cover to the blade, the housing having a first end and a second end, the blade being configured for being elongated from the first end to the second end, the housing having a center on a surface of the housing;
an arm being coupled to the housing by an articulation point, the articulation point being positioned on the center of the surface of the housing, the arm being positioned parallel relative to the blade, the arm being positioned proximate to the first end of the housing of the blade, the arm having an interior defining a space for a variety of elements to be positioned within;
a lever being positioned within the interior of the arm, the lever being configured for moving the housing from a lowered positioned to an upper position and vise versa, the lever having a plurality of heating coils;
a motor being positioned on an end of the lever, the motor being configured for moving the lever whereby moving the housing;
a motor control being in electric communication with the motor, the motor control being configured for being an actuator to the motor;
a microprocessor being in electric communication with the plurality of heating coils, the microprocessor being configured for being an actuator to the plurality of heating coils;
a power source being a battery, the power source being configured for sending electric power to the mechanized windshield wipe device;
a pair of control switches being configured for sending commands to a respective one of the microprocessor and the motor control; and
a wireless control being in remote communication with a remote device, the wireless control being in electric communication with the microprocessor and the motor control.
